(19) United States
(12) Patent Application Publication
(10) Pub. No.: US 2016/0323143 A1
(43) Pub. Date: Nov. 3, 2016

(54) Method and apparatus for neuroplastic internet of things by cloud computing infrastructure as a service incorporating reconfigurable hardware

(71) Applicants: Hyeung-Yun KIM, Palo Alto, CA (US); Paul Jaeho KIM, Palo Alto, CA (US)

(72) Inventors: Hyeung-Yun KIM, Palo Alto, CA (US); Paul Jaeho KIM, Palo Alto, CA (US)

(73) Assignees: HYEUNG-YUN KIM, Palo Alto, CA (US); PAUL JAEHO KIM, Palo Alto, CA (US)

(21) Appl. No.: 14/999,342

(22) Filed: Apr. 25, 2016

Related U.S. Application Data
(60) Provisional application No. 62/179,233, filed on May 2, 2015.

(51) Int. Cl. H04L 12/24; H04L 29/06; H04L 29/08; G06F 3/06; G06F 12/14

(52) U.S. Cl. CPC H04L 41/0816; G06F 3/0604; G06F 3/0629; G06F 3/0647; G06F 3/067; G06F 12/1408; H04L 67/12; H04L 67/10; H04L 67/42; G06F 2212/402

(57) ABSTRACT

IoT embedded systems as well as cloud computing infrastructure may merge processor soft cores with programmable logic (FPGAs) to yield a heterogeneous hardware-software processing ecosystem through which the embedded systems and infrastructure customize and adapt their computational power to the specific application in use. The embedded systems and cloud computing infrastructure with dynamic reconfiguration will bring neuroplasticity to the interconnected space of IoT embedded systems, enabling high-performance, customized, secure-by-design cloud computing services. A cloud server of IaaS is employed to evaluate the performances and efficiencies of embedded systems according to its hardware architectures, so that the computing service allow one reconfigurable system download its hardware architecture file or bitstream into other embedded systems via the cloud server.

### CROSS REFERENCE TO RELATED APPLICATIONS

This application claims the benefit of U.S. Provisional Applications No. 62/179,233, entitled “Method and apparatus for reconfigurable internet-of-things control platform with cloud server”, filed on May 2, 2015, which is hereby incorporated herein by reference in its entirety.

### BACKGROUND

Embedded computing, in one way or another, is present everywhere in our daily life. The combination of hardware and software to perform specific functions is applied in multitude of scenarios. The flexibility provided by run-time partial reconfiguration together with the potential for implementing large circuits on limited hardware resources are earned values that make run-time reconfigurable systems an excellent choice for implementing a wide range of low-cost embedded applications. The deployment of this technology involves, in general, to redesign the current solutions from scratch since the requirements inherent to this technology have changed, due especially to the new time-space concept introduced in this approach up to now not present in other technologies like a purely software or static hardware solution based on a Von Neumann or Harvard MCU, DSP, GPU or ASIC.

By means of reconfiguration technology, all these resources can be highly customized to the instantaneous needs of an application, where the configurable structures are changed during circuit operation, allowing the computational resources to be reused in time. The main goal behind the temporal and spatial partitioning of reconfigurable logic resources is to achieve the highest efficiency of reconfigurable systems, taking the maximum advantage of parallelism, resource usage and flexibility. This approach is viable when the target application can be decomposed into a set of functions or stages executed sequentially following a batch process, where each one of such serial stages, in its turn, is decomposed in a subset of tasks running in serial and/or in parallel instantiated on demand in the same set of shared resources. As a result, the functionality demanded by the application can be performed on the minimum number of processing elements possible at expenses of raising at maximum its usage or functional density. Moreover, usually the reconfiguration latency is sufficiently small, typically in the order of a few milliseconds or less, for those functions to be swapped in real-time.

Since the configuration of SRAM-based FPGAs can be changed by a completely electrical process performed by a specific engine, either at run-time or off-line, SRAM-based FPGAs become the workhorse of numerous reconfigurable applications. These devices contain an array of LUTs for synthesizing combinational functions, flip-flops for sequential finite state machines, memory blocks for data storage, DSP blocks for compact signal processing, clock management blocks for configuring system clocks, and interconnection nets to link all these resources giving rise to a made-to-measure computing system.

To maximize performance in such applications, designs must tightly couple the FPGA and microprocessor instead of treating each as independent entities. State-of-the-art FPGA devices make possible to implement all the functionality associated to an embedded system in a single chip: one or more hard- or soft-core processors can be placed there along with additional programmable logic to synthesize standard or custom coprocessors. Thus, many platforms tightly integrate today the MCU+FPGA combination and a development tools ecosystem allow an embedded design team to optimally partition their implementation by means of hardware/software co-design. In this direction, Xilinx announced the new generation of the so-called extensible processing platforms (EPP) composed of its Zynq-7000 family of devices. Some months later, Altera announced the new generation of SoC FPGAs Arria-V and Cyclone-V devices. Besides, in the end of 2011, Xilinx started the shipment of the Virtex-7 2000T FPGA device—the world's highest capacity programmable logic device ever built provided with 6.8 billion transistors on a single chip—and the Zynq-7020 EPP, while Altera released the Arria-V SoC FPGA.

All these FPGA devices that merge one or more hard core processors with reconfigurable fabric are referred to by the FPGA vendors as programmable system-on-chip (PSoC), system-on-programmable-chip (SoPC), SoC FPGA or extensible processing platform. Independently of the name, it refers to an efficiently coupled MCU+FPGA architecture packaged in a single chip. As example, in some of these devices the coupling between the processor system—an ARM CPU—and the programmable logic is performed through a high-bandwidth AMBA-AXI interconnect.

At a fundamental level, reconfigurable computing is the process of best exploiting the potential of reconfigurable hardware. FPGA vendors announced their next-generation devices featuring dynamic reconfiguration as part of their strategy to take programmable logic forward to higher densities and throughputs. Altera announced its Stratix-V FPGA equipped with placement-routing (PR) capability as well as the introduction of the PR design flow integrated into its classical Quartus-II tool. Just to name some of the most important milestones recently achieved, Xilinx presented in 2010 a new PR design flow, inspired in its previous early access PR modular design flow, based now on partitions. The most relevant highlight of this PR flow is the fact that it is released as mainstream in the design toolset, integrated in the standard tools.

Although the hardware/software co-design flow (hardware/software partitioning, design synthesis, placement, routing, technological mapping, bitstream generation, co-verification) is more complex than the design flow used in a purely-software approach (software edition, compiling and linking), in the 2000s the FPGA flow was fully available for implementing static or off-line reconfigurable designs but not for covering run-time reconfigurable systems. Devices and tools became powerful enough to deal with most static hardware designs.

Nevertheless, this feature has only gained big attention recently, becoming a potential implementation alternative of embedded systems based on FPGA devices due basically to the software enhancements of EDA tools carried out in the last years. For this goal, Xilinx released what probably might be considered the first mature partial reconfiguration design flow provided with automated CAD tools. Such design methodology is built around the PlanAhead tool and definitely makes dynamic reconfiguration feasible, turning it from a heroic activity to a reliable design process. These tools presented further technological enhancements on its architecture oriented to PR like finer reconfiguration granularity and improved reconfiguration bandwidth. Hence, a new era of run-time reconfigurable computing began. Recently, new tools that allow the FPGA design to become increasingly hardware-independent have been developed (e.g. Simulink model-based design from MathWorks, allowing the use of behavioral descriptions as design entry converted then automatically in HDL code).

Reconfiguration can be seen as an integral feature of modern SoC based embedded systems. A reconfigurable SoC offers increased functional extensibility in return for lower performance. Dynamic reconfiguration enables system modification at run-time, introducing the concept of virtual hardware. Currently, FPGA-based SoCs offer an ideal solution for implementing dynamic reconfiguration. Moreover, SoC application functionalities can be easily implemented as hardware designs on these reconfigurable SoCs. Normally, these systems also integrate some sort of a reconfiguration controller that manages the reconfiguration process between the static and dynamically reconfigurable regions of the system.

The dynamic reconfiguration implies that an active device may be partially reconfigured, while ensuring the correct operation of the rest of active circuits that are not being changed. This is known as partial reconfiguration and refers to the ability to dynamically modify blocks of a programmable logic device by downloading partial bitstream files while the remaining logic on the device continues to operate without interruption.

A reconfigurable system might also incorporate some controlling processors which are coupled with, or embedded in the fabric. The processor(s) can execute non-critical code sequentially while key kernels of application that are time critical, exhibit high degree of parallelism and could be efficiently mapped to hardware. These mapped tasks/functions can take advantage of the parallelism achievable in a hardware implementation. Thus the interfaces between the processor(s) and the fabric, as well as the interfaces between the fabric and the available memory are of utmost significance. Finally, a system designer can develop the optimal combination of functional and storage units in the reconfigurable fabric, providing an architecture that supports the application.

These reconfigurable systems normally consist of a matrix of large reconfigurable fabric (i.e. computational units), along with a dense reconfigurable routing network superimposed on the fabric. This fabric permits creation of custom functional units. These systems embed fine or coarse-grain elements (logical functions, operators, memory blocks, etc.) which are organized into clusters. The main characteristics are normally spatial computation, distributed control, distributed resources and presence of a configurable data-path. Also reconfigurable systems can be classified on the basis of several parameters: granularity defined as the size of its smallest functional unit; degree of coupling in reconfigurable fabric relying on an I/O interface to communicate with a processor; types of fixed or reconfigurable interconnect networks for communication between host and reconfigurable fabric, as well as between configurable logical and functional blocks attached with the host; types of reconfiguration either static (passive) or dynamic (active) in nature where both types of reconfigurations can either be full or partial depending upon the nature of the reconfigurable architecture and design specifications.

A reconfigurable SoC offers the same type of custom IP support except that the IP is implemented using the reconfigurable fabric. The software must set up the hardware before it can be used. Co-design of these reconfigurable SoCs permits application partitioning as well as performance estimation techniques for evaluation of hardware/software implementations. Afterwards, integrated tools enable co-validation, co-simulation and design testing/de-bugging.

Reconfigurable computing is also an emerging paradigm for present and future computing requirements of embedded applications, in terms of flexibility and performance. Much works have been realized related to run-time reconfigurable systems, and optimizations of the related low level technical details, with two general disciplines. On the one hand, the transverse disciplines of reconfigurable computing technology focus on the design of embedded system architectures driven by the synthesis of digital circuits. One of the horizontal disciplines deals with the hardware/software co-design of embedded systems on programmable logic.

One area of the horizontal disciplines is hardware-based cloud solutions supporting the key attributes of security, high performance and flexibility, illustrated by industry use cases: Google Project Vault, which embeds cryptographic computing synthesized in hardware into a microSD device; the FPGA-based Microsoft Azure SmartNIC, allocated in the servers to offload software-defined networking functions from the CPU; the Catapult Project, a Bing's search engine through FPGA technology; and the Bitfusion Cloud Adaptor initiative, which lets developers use FPGAs in the cloud; the FPGA data center servers, the Xilinx Kintex Ultra-Scale FPGA and Xilinx Zynq Ultrascale+ MPSOC device series are valid examples.

Another area of the horizontal disciplines is the design of operating systems for reconfigurable embedded platforms to provide increased usability for reconfigurable platforms, with a focus on simplifying hardware/software co-design. For example, BORPH-the operating system for reconfigurable platform implemented in the extension of Linux system kernel are designed, so that reconfigurable resources are treated as computational resource in the operating system. Like this, abstracting an entire FPGA, or partially reconfigurable regions within a single FGPA, as hardware regions allow the kernel to deal with the platform specific details and removes the need for application designer to address these low level implementation details.

Research has proved that the brain is also in fact plastic; it dynamically alters its structure, functions and neural connections, even growing new neurons via neurogensis, in response to environmental stimuli and though the very act of thought. The neuroplastic analogy to dynamic reconfiguration of embedded systems should initiate disruptive neuroplasticity and morphogenesis of IoT systems as a new horizontal discipline of reconfigurable computing technology.

The present invention relates to associating the reconfiguration data or bitstreams between reconfigurable embedded systems, expressed as the new term of “reconfiguration network” for self-adaption or evolution, founded on cloud computing infrastructures as a service (IaaS) where IaaS is a way of providing cloud computing hardware infrastructure (servers, storage, network and operating systems) as an on-demand service over the Internet. Moreover this invention may bring about a business model of brokering the intellectual property (IP) cores of reconfigurable IoT systems via cloud computing infrastructure. The present invention extends the dynamic reconfiguration concept to specialized autonomous devices where specific circuits of the device itself are used to control the reconfiguration of other parts of the device, being the integrity of these control circuits guaranteed during reconfiguration.

The goal of the invention should be the construction of hardware/software “artifacts” that self-adapt and evolve beyond the reconfiguration network through cloud computing services. The preference of this invention is given to works that demonstrates adaptability of IoT reconfigurable systems in the “real world” and that does not simply extrapolate from an already established artificial intelligence research field (neural networks, genetic or machine learning algorithms for active sensing systems, disclosed in U.S. Pat. No. 7,286,964).

### SUMMARY OF THE DISCLOSURE

This invention will introduce the term of “neuroplastic IoT infrastructure” to describe networking IoT embedded systems through physical cloud computing infrastructure. Also the reconfigurable computing technology is available in SRAM-based FPGA and SoCs for IoT embedded systems and the cloud computing infrastructure.

According to one embodiment of the present invention, the computing service provides a reconfigurable IoT compute platform for the neuroplasticity of computing hardware by which embedded systems can evolve cloning smart computing hardware architecture from other embedded systems, and updating kernel and execution programs in cloned reconfigurable processors. The reconfigurable IoT compute platform of this invention can be applicable in the area of robots, drones, smart cars, smart-home electronics, health-care devices, smart factories and grids, as well as a distributed computing system comprising multiple processors attached or embedded in objects. For the computing service, a cloud server of IaaS is employed to evaluate the performances and efficiencies of embedded systems according to its hardware architectures, designed via hardware-description-language (HDL), and execution programs updated by the compute platform, so that the computing service allow one reconfigurable system download its hardware architecture file or bitstream into other embedded systems via the cloud server.

According to another embodiment of the present invention, the computing service may provide the reconfiguration data of FPGA-based hardware architecture by networking reconfigurable systems including reconfigurable device such as FPGA devices and PSoC device. The computing service establishes a network connection to interact with at least one of the provider's reconfigurable systems and one of the subscriber's reconfigurable systems where each of the providers and the subscriber of reconfiguration data may be the user of reconfigurable embedded systems.

According to yet another embodiment of the present invention, the human brain neurogensis may be inspired with the morphogenesis of computing hardware architectures by creating the network connection between the reconfigurable systems linked to IaaS server, where neuron and neural connection are abstracted to reconfigurable system and computing-hardware architecture data respectively, which comprise hardware architecture or reconfiguration bitstream, downloaded for the resources of reconfigurable FPGA/Soc devices to be configured, its information, and source and destination addresses of the network. The reconfiguration network, newly introduced in the area of dynamic reconfiguration technology, may allow the computing service of the present invention to bring about the neuroplasticity of computing service as well as the morphogenesis of reconfigurable embedded systems distributed in the real world.

According to yet another embodiment of the present invention, for self adaptation of reconfigurable systems the network management software modules in the reconfigurable IoT platform may employ a language with semantics describing the commands and functional tasks required in the computing service. The network management modules may create a reconfiguration data comprising the network address and application port, the reconfiguration control and status information, and reconfiguration bitstream applied to each reconfigurable device.

According to yet another embodiment of the present invention, each placement/routing application module running on the reconfigurable systems may use not only full reconfiguration for one single-context FPGA, but also partial reconfiguration for partially reconfigurable FPGA, whereas FPGA resources including configurable logic blocks (CLBs) are configured by downloading the configuration bitstream. The placement/routing software modules may also employ a bitstream format composed of a series of configuration commands and configuration data corresponding to the data written into the FPGA configuration memory, where the commands encompass the handling of the internal registers of the configuration logic. The placement/routing software modules may employ external interface for the bitstream repository of the configuration data such as non-volatile memory device, or a secondary PLD, or even a general-purpose microprocessor.

According to yet another embodiment of the present invention, the reconfiguration management software module running on the server of IaaS may interrogate each reconfigurable system to find out why the computing service is doing reconfiguration tasks, and the reconfiguration management maintains an abstract view of what the reconfigurable systems are doing and how the computing service creates the reconfiguration bitstreams for the adaptation and evolution of the reconfigurable systems.

According to yet another embodiment of the present invention, the reconfiguration management software module running on the IaaS server of the computing service may generate the genotype of the reconfiguration architecture or FPGA/SoC bitstream deployable in reconfigurable systems by evaluating the function and performance of the phenotype of the reconfigurable systems affiliated in a reconfiguration network. The reconfigurable systems are evolved searching a genotype from hardware architecture network, which may be a reconfigurable device with better performance, and cloning the genotype reconfiguration bitstream and downloading the bitstream into the FPGA resources of each the remaining devices to be configured. The reconfiguration management software module may exploit an introspective machine such as Lamarckian evolution for the adaptation and evolution of reconfigurable systems.

According to yet another embodiment of the present invention, each reconfigurable system, coupled with sensors of different types, may have each operating system employing an application software module comprising one of multilayered-neural-network components for self-adaptation, so that it can make local decisions on different time scales, uncertain and incorrect information from the environment etc. The design parameters and partial reconfiguration bitstreams of adaptation generated by these autonomous components are downloaded back to the data-center server of the computing service, so to bring about not only the neuroplasticity and morphogenesis of reconfigurable systems but also the neuroplasticity of the reconfigurable data-center server.

According to yet another embodiment of the present invention, a reconfigurable system with the reconfigurable device of FPGA may employ the main controller for the network-based dynamic reconfiguration of IoT embedded systems. The reconfigurable system includes a reconfiguration memory as the repository of reconfiguration data or bitstream download from the cloud computing server of the neuroplastic reconfiguration service.

According to yet another embodiment of the present invention, a reconfigurable system with the reconfigurable devices may employ a master of the reconfiguration controller. The FPGA device works as PSOC comprising a Ethernet transceiver with media-independent interface (MII) wired to giga Ethernet connection while the order two device interfaced with one wireless controller including Wi-Fi and long-term-evolution (LTE) system-on-chips are available in the signal processing blocks.

According to yet another embodiment of the present invention, an IoT platform consisting of a server-side application software implemented together with the computing service software, and one of reconfigurable embedded systems having a FPGA device, allowing an user application to interact with the reconfigurable system through the application found on the cloud computing server of IaaS.

According to yet another embodiment of the present invention, a server-side application software operated with the network management and placement/routing application software modules, including a web-server application and computing application found on the cloud computing server. The web-server application may include a HTTP server, a HTTP accelerator, and the gateway interface. The server-side application may include the reconfiguration application threads related to the reconfiguration network management and the placement routing, the control application threads for the operational control of reconfigurable systems, and the processing application for the computation of sensor data.

According to yet another embodiment of the present invention, a reconfigurable system comprising a non-reconfigurable controller connected with a reconfigurable FPGA PSoC controller. The non-reconfigurable controller may include the peripheral controllers of GPIOs, parallel-bus memory interface and SPI, allowing the controller to communicate with the PSOC controller. The non-reconfigurable controller is running on an operating system or kernel incorporated with the software modules of Internet protocol layers and user applications.

According to yet another embodiment of the present invention, a cloud-computing architecture providing the neuroplastic reconfiguration service, implemented in a cloud server of IaaS. The cloud-computing architecture as the structure of the system comprising cloud resources, services, middleware, and software components, and the relationship between them has two datapath tracks: the first track is the data-path of streaming reconfiguration data for dynamic reconfiguration, and the second track is the data-path of streaming the information on the requests on the user services or the sensor data retrieved from a number of reconfigurable systems. The cloud-computing architecture may have three virtual network layers interconnecting the cloud resources or computes: the first virtual network layer for application/web-service, the second virtual network layer for processing, and the third virtual network layer for streaming reconfiguration and information data.

According to yet another embodiment of the present invention, a computer readable medium may carry one or more sequences of instructions for establishing a network connection to interact with a plurality of reconfigurable systems, designated as one of the provider and subscriber of reconfiguration data, and monitoring the performance of each reconfigurable system by analyzing the sensor data transmitted to the computing service.

According to yet another embodiment of the present invention, a system for establishing a network connection to interact with a plurality of reconfigurable systems, designated as one of the provider and subscriber of reconfiguration data, and monitoring the performance of each reconfigurable system by analyzing the sensor data transmitted to the computing service.

### BRIEF DESCRIPTION OF THE DRAWINGS

FIG. 1 is a schematic diagram of the computing service providing a reconfigurable IoT compute platform for the neuroplasticity of computing hardware in accordance with one embodiment of the present teachings.

FIG. 2 is a schematic diagram of a reconfigurable system with the reconfigurable device of FPGA employing the main controller for the network-based dynamic reconfiguration of IoT embedded systems in accordance with one embodiment of the present teachings.

FIG. 3 is a schematic diagram of a reconfigurable system with the reconfigurable devices employing a master of the reconfiguration controller in accordance with one embodiment of the present teachings.

FIG. 4 is a schematic diagram of an IoT platform consisting of a server-side application software implemented together with the computing service software, and one of reconfigurable embedded systems having a FPGA device in accordance with one embodiment of the present teachings.

FIG. 5 is a schematic diagram of a server-side application software operated with the network management and placement/routing application software modules, including a web-server application and computing application found on the cloud computing server in accordance with one embodiment of the present teachings.

FIG. 6 is a schematic diagram of a reconfigurable system comprising a non-reconfigurable controller connected with a reconfigurable FPGA PSoC controller in accordance with one embodiment of the present teachings.

FIG. 7 is a schematic diagram of a cloud-computing architecture providing the neuroplastic reconfiguration service in accordance with one embodiment of the present teachings.

### DETAILED DESCRIPTION OF THE PREFERRED EMBODIMENTS

Although the following detained description contains many specifics for the purposes of illustration, those of ordinary skill in the art will appreciate that many variations and alterations to the following detains are within the scope of the invention. Accordingly, the following embodiments of the invention are set forth without any loss of generality to, and without imposing limitation upon, the claimed invention.

Cloud computing is very intriguing because it enables innovation and business transformation fueled by ever-growing computational power while decreasing their costs. Cloud solution leaders such as Amazon, Microsoft, IBM, Intel, Qualcomm and Baidu, together with FPGA vendors, are strongly advocating for FPGA optimization of data center workloads since FPGAs should be the future enablers of application-specific accelerators in cloud computing servers.

Now, the ever-increasing trend to add new and more complex functionality into current embedded applications or products also leads to an exponential growth of the computational power demanded to such electronic systems, putting special pressure on design aspects like cost, performance and time. In this context, reconfigurable computing driven by run-time reconfigurable hardware emerged as an alternative computing paradigm to implement embedded applications based on a well proven technology today, qualified to improve valuable implementation features like performance, scalability and versatility of electronic systems, and promising furthermore speed-up factors and energy savings by up to several orders of magnitude compared to classical software-based approaches mapped on DSPs, MCUs, GPUs, or even in FPGA or SoC devices used as static hardware designs.

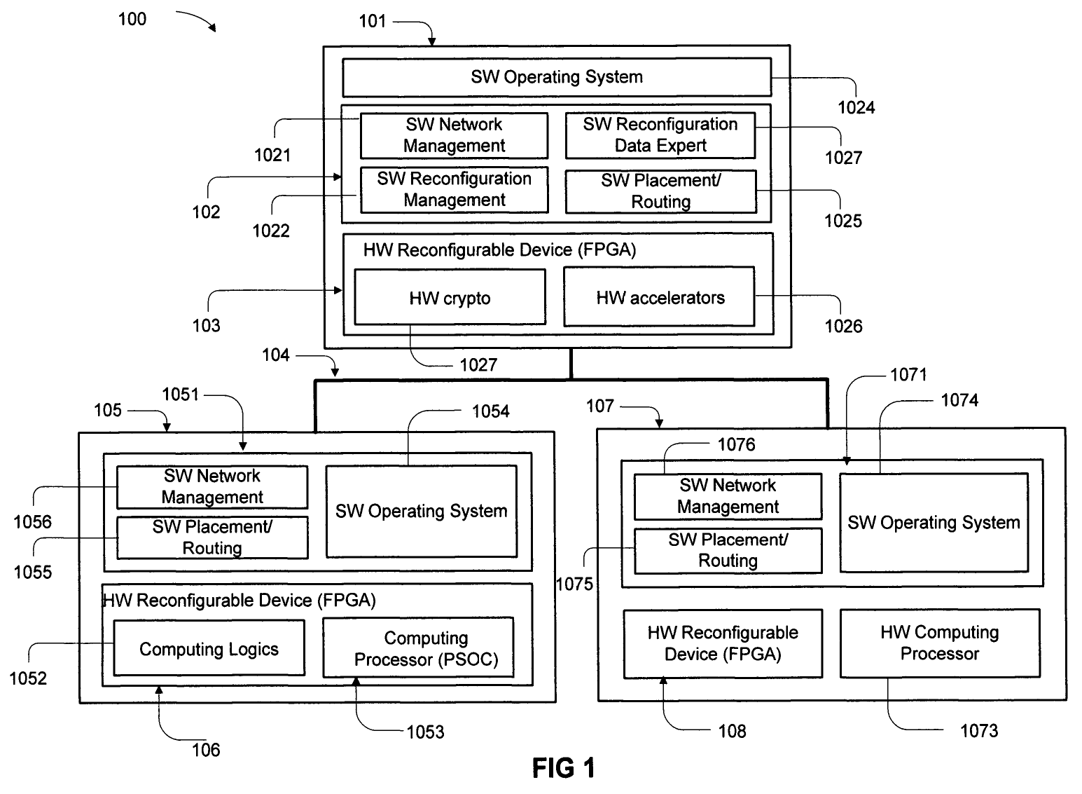

As a reconfigurable IoT compute platform illustrated in FIG. 1, the computing service 100 of the present invention considered with an application software system of business model, teaches the method and apparatus for the neuroplasticity of computing hardware by which embedded systems 105 and 107, such as robot and drone, can evolve renewing the computing hardware architectures as well as operating system or kernel, and execution programs running in reconfigurable processors, for which the both hardware and software of reconfigurable systems are updated by the computing service 100. Furthermore the operating system and application program running on the non-reconfigurable master controller or MCU of reconfigurable systems 105 and 107 may be updated by the computing service 100. For the computing service, a cloud server of IaaS is employed to evaluate the comparative performances and efficiencies of up-to-advance hardware implementations for reconfiguration data and execution programs to be updated, so that the computing service allow one reconfigurable system download its hardware architecture file or bitstream into other embedded systems 105 and 107 via the cloud server.

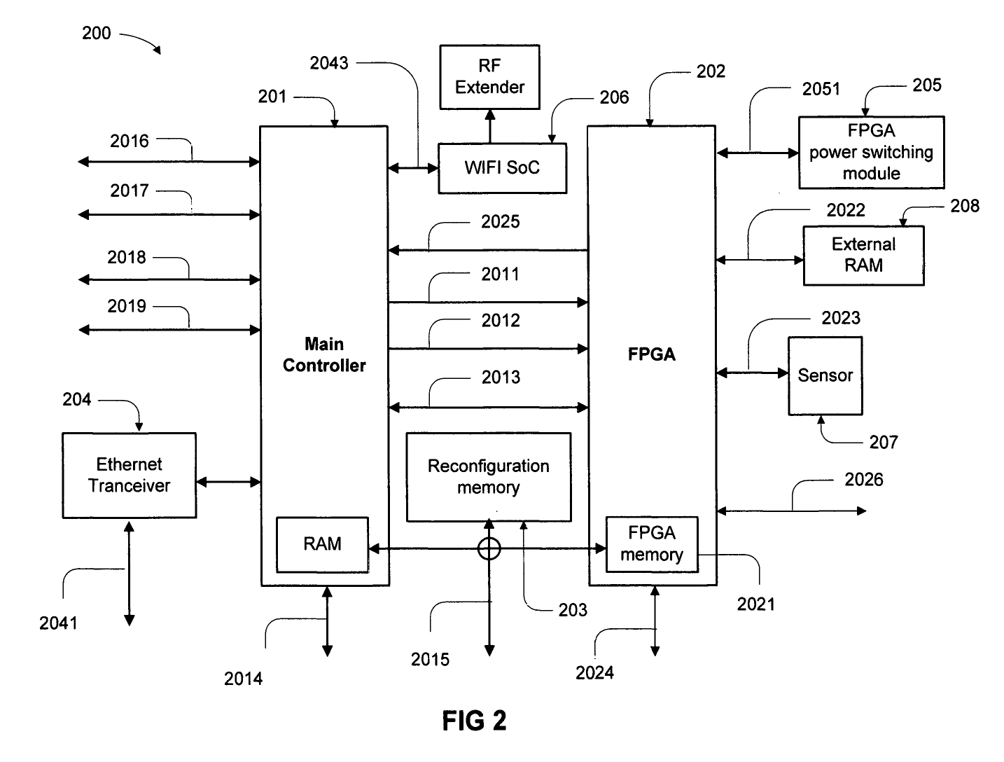

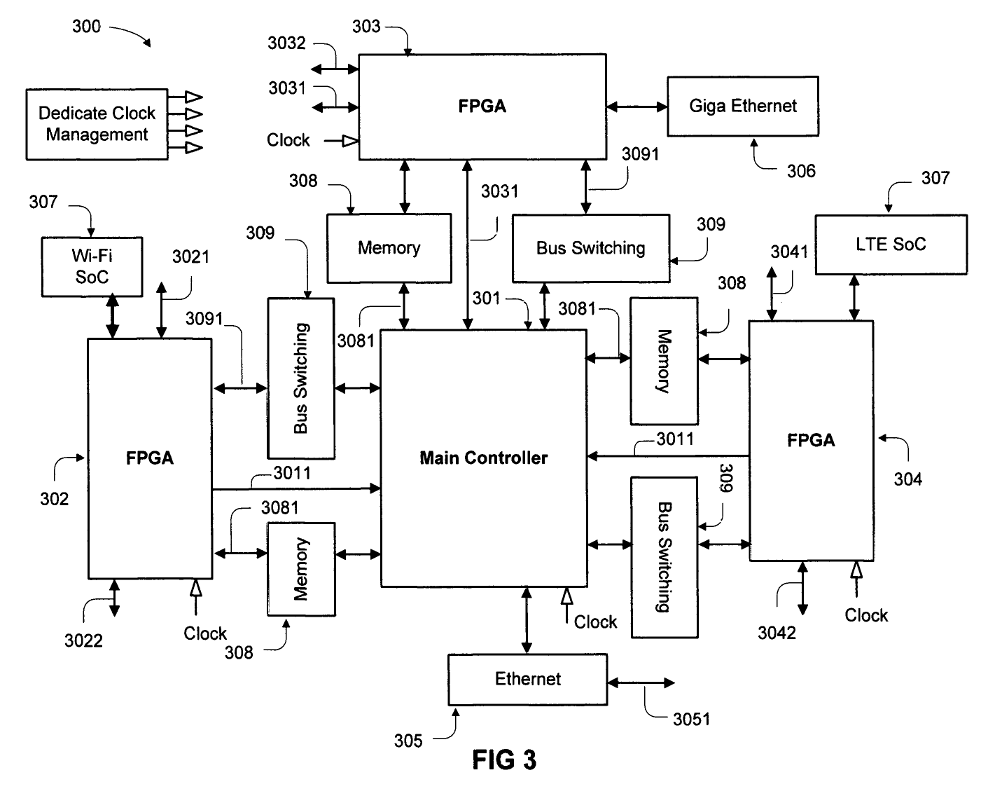

In one embodiment of the invention, the computing service 100 may provide reconfiguration data of FPGA-based hardware architecture by networking reconfigurable systems 101, 105 and 107 as well as 200 and 300 shown in FIGS. 2 and 3, including reconfigurable device such as FPGA devices 103, 106 and 108 and PSoC device 1053. The computing service 100 establishes a network connection 104 to interact with at least one of the provider's reconfigurable systems 105 and one of the subscriber's reconfigurable systems 107 where each of the providers 105 and the subscriber 107 of reconfiguration data may be the user of reconfigurable embedded systems. Moreover, for the adaptation and evolution of reconfigurable systems, each embedded system 105 or 107 may provide the reconfiguration data to other embedded systems acting as subscriber. Like this, to extend the computing service 100 of the present invention to between servers found on cloud computing IaaS, the reconfigurable system may be a FPGA-based computing server 101 of IaaS data center. One of provider's reconfigurable systems 105 or 200 sends the reconfiguration data in its reconfiguration memory repository, 203 as shown in FIG. 2 so that the computing service 100 stores the reconfiguration data into a computing-service database of the computing service. Another of reconfigurable systems 107 and 200 receives reconfiguration data transmitted from the computing service 100 to finally download the reconfiguration data via its reconfiguration memory 203 into the FPGA memory 2021 to configure its reconfigurable device 108 or 202.

According to an embodiment of the present invention, the human brain neurogensis may be inspired with the morphogenesis of computing hardware architectures by creating the network connection 104 between the reconfigurable systems 105 and 107 linked to IaaS server 101, where neuron and neural connection are abstracted to reconfigurable system and computing-hardware architecture data respectively, which comprise hardware architecture or reconfiguration bitstream downloaded for the resources of reconfigurable FPGA/Soc devices to be configured, its information, and source and destination addresses of the network. The computing service 101 of IaaS with different adaptation models drives learning process of the reconfigurable systems 105 and 107, and manages the network or graph of hardware architectures or reconfiguration bitstreams. In this invention, minimizing the reconfiguration latency may be achieved searching the shortest route in the network as a high bandwidth link between the reconfiguration bitstream repository located in IaaS and the FPGA configuration memory in each reconfigurable system 105 and 107 (like as active sensor network, disclosed in U.S. Pat. No. 7,325,426).

The reconfiguration network, newly introduced in the area of dynamic reconfiguration technology, may allow the computing service 100 of the present invention to bring about the neuroplasticity of computing service as well as the morphogenesis of reconfigurable embedded systems 105 and 107 distributed in the real world. In the context of this goal, the computing service 100 relates to associating the reconfiguration data or bitstreams between reconfigurable embedded systems 105 and 107 via the network connection 104, founded on a cloud computing infrastructures as a service (IaaS) where the cloud computing IaaS on the computing server 101 is a way of providing cloud computing hardware infrastructure (servers, storage, network and operating systems) as an on-demand service over the Internet. The computing service 100 of the present invention also relates to a business model of brokering the intellectual property (IP) cores of reconfigurable systems via cloud computing infrastructure. Furthermore the computing service 100 of the present invention may extend the dynamic reconfiguration concept to specialized autonomous devices where specific circuits of the device itself are used to control the reconfiguration of other parts of the device, being the integrity of these control circuits guaranteed during reconfiguration.

In one embodiment of the invention, to adapt reconfigurable systems 105 and 107 the network management software modules 1021, 1056 and 1076 may employ a language with semantics describing the commands and functional tasks required in the computing service 100. The network management modules 1021, 1056 and 1076 may create a reconfiguration data comprising the network address and application port, the reconfiguration control and status information, and reconfiguration bitstream applied to each reconfigurable device. Moreover the reconfiguration data are encapsulated in packets, where a packet contains two different sections: header and data. The header can specify the reconfiguration network, control and status for adaptation, and configuration command (i.e. configuration registers addressed) to the desired interface followed by the configuration data, whereas the data contains the configuration frame to be downloaded into the configuration memory of FPGA devices 103, 106 and 108. The reconfiguration network software module 104 may be adapted to employ a link layer including one of address resolution protocol (ARP) and point-point protocol (PPP), a Internet layer including one of Internet protocol (IP) and multi protocol label switching (MPLS), Internet command message protocol (ICMP) and Internet group management protocol (IGMP), a transport layer including one of transmission control protocol (TCP) and user datagram protocol (UDP), an application layer including one of extended markup language (XML), hyper text transfer protocol (HTTP), file transfer protocol (FTP), simply network management protocol (SNMP), real-time transport protocol (RTP), MQ telemetry transport (MQTT), data distribution service (DDS), constrained application protocol (CoAP), and 6LoWPAN etc. The reconfiguration network 104 may also employ Ethernet, Wi-Fi, 3G/4G long term evolution (LTE) and programmable logic controller (PLC).

In one embodiment of the present invention, the computing service 100 of the present invention may evaluate the comparative performance of up-to-advance, or up-to-date, hardware implementations for reconfiguration data of reconfigurable systems 105 and 107. For this goal, the computing service 100 may employ a reconfiguration management 1022 including application modules related to analytics and artificial intelligence to generate the reconfiguration data or bitstreams by which the reconfigurable systems 105 and 107 can adapt and optimize their reconfigurable computing hardware logics 1052 and 108, as well as processing architecture logic 1053. The reconfigurable hardware of processing architecture logic 1053 may be one of the processor allocated in embedded controllers distributed in IoT real world, as well as the server itself 101 allocated in the data centers of any cloud computing infrastructures to neuroplastic computational needs.

In one embodiment of the present invention, the computing software system of the cloud computing server 101 may include a reconfiguration data expert 1027 of the software module including analytics and artificial intelligence. Perhaps the greatest advantage of artificial neural network (ANN) is their ability to be used as an arbitrary function approximation mechanism which ‘learn’ from observed data. This is particularly useful in the computing service 100 where the complexity of the reconfiguration data or task makes the design of such a neuroplastic reconfiguration function by hand impractical. By this reason, the reconfiguration data expert 1027 may generate the reconfiguration data of a application-specific neural network hardware by preferably employing ANNs on FPGA devices, since the hardware implementation of ANNs can take full advantage of their inherent parallelism and thus can achieve much better performance by orders of magnitude compared to their counterparts simulated in software. Also the reconfigurable systems 105 and 107 can be applied to one of FPGA-based application specific network architectures, covering broad categories such as image and video processing, audio processing, industrial automatic control, medical applications.

An artificial neural network is essentially a parallel and distributed network of simple nonlinear network processing units interconnected in a layered topology. Parallelism, modularity, and dynamic adaptation are three most noticeable and important computational characteristic associated with ANNs. The inherent regularity, homogeneity and reconfigurablity of FPGAs make it a perfect candidate platform to implement ANNs, since it is able to quickly reconfigure itself to adapt any changes in the internal parameters and overall behaviors of an ANN. In one embodiment of the present invention, the reconfiguration data expert 1027 may employ one of artificial neural network implementations, to generate the ANN hardware architecture implemented on the reconfigurable systems 105 and 107 as well as on the FPGA used in the server of the computing service 100, including a multilayered perception neural network, a feed-forward back-propagation neural network, a radial basis function network of interpolation in multi-dimensional space, an unsupervised neural network such as self-organizing map, a recurrent neural network, a probabilistic neural network and a spiking neural network. In pattern recognition for clustering and classification, the reconfiguration data expert 1027 may use the self-organizing map which have competitive learning models that can capture the topology and probability distribution of input data. Recurrent neural networks can handle dynamic information processing unlike ordinary feed-forward neural networks. Probabilistic neural network is one of the statistical pattern recognition techniques and built by introducing random variations into the network. Spiking neural network incorporate the concept of time into their operating model, in addition to neuronal and synaptic states, so that it generates behaviors and reproduces coding schemes analogous to biological neural systems.

In one embodiment of the present invention, in order to increase the number of reconfigurable hardware neurons, the computing service 100 may also a multi-placed reconfiguration by dividing a algorithm into sequential execution of multiple stages, preparing multiple reconfiguration bitstreams for each execution stage, and configuring multiple FPGA devises placed at multiple locations with their corresponding bitstreams for the algorithm. The computing service 100 may also employ a run-time reconfiguration by dividing the back-propagation algorithm into the sequential execution of three stages known as feed-forward, back-propagation and update, and configuring the FPGA devices to execute only one stage at time. It allows the FPGA device switching between back-propagation training and feed-forward computation by loading certain reconfiguration data from the reconfiguration repositories. Furthermore all software application modules in the computing service 100 may employ these ANNs implemented in the network management 1021, the reconfiguration data management 1022, the placement/routing application 1025 as well as the reconfiguration data expert 1027.

In one embodiment of the invention, a plurality of groups of reconfigurable computing systems 105 and 107 may be assigned to the members of a subordinate network connection in the main reconfiguration network to implement the morphogenesis of hardware architectures. For the morphogenesis of hardware architectures, the reconfigurable systems 105 and 107 may contain adaptive mechanisms with multiple levels to changes in their environment stimuli and the very act of user services. The reconfigurable systems 105 and 107 associated with each morphogenesis sub-network group created in the main network connection 104 may operate in different ways, on different time scales and possibly at different points in the life span of reconfigurable devices.

Each placement/routing application module 1025, 1055 and 1075 running on the reconfigurable systems 101, 105 and 107 may use not only full reconfiguration for one single-context FPGA 108, but also partial reconfiguration for partially reconfigurable FPGA 106, whereas FPGA resources including configurable logic blocks (CLBs) are configured by downloading the configuration bitstream. Open, only a part of the FPGA resources require modification, so a partial reconfiguration of the FPGA 106 is needed rather than a full reconfiguration. For this purpose, the bitstream format shall contain the specific position of the addressed resource—since address information must be supplied with configuration data—the total amount of information transferred to the reconfigurable hardware may be greater that what is required with a single context design where in this case the address can be implicitly specified through the sequence of the bitstream information. The reconfigurable FPGAs 103 and 106 may treat PR regions or partitions as rectangles to be placed at an arbitrary position inside the larger two-dimensional sea of resources distributed along the device. This partial reconfiguration provides a greater flexibility in choosing the best floor planning and mapping of reconfigurable tasks inside the device. One of the reconfiguration application module 102 in the computing cloud server 101 of IaaS or the reconfiguration software module 1051 and 1071 of the embedded may also use a multi-context FPGA as a set of planes of resources from single context FPGAs working in a multiplexed way, where only one of these configuration planes is active at any given time. The multi-context FPGA includes multiple memory bits for each programming bit location, in the way that these memory bits can be thought of as multiple planes of configuration information.

According to an embodiment of the present invention, the placement/routing software modules 1025, 1055 and 1075 running on the reconfigurable systems 101, 105 and 107 may integrate the current FPGA generation tools (synthesis, floorplan, map, placement and routing) inside the computing server 101 of the IaaS service or the reconfigurable embedded system 105 and 107 in order to build from there the partial bitstreams demanded at each time. With these tools, the placement/routing software modules 1025, 1055 and 1075 can perform synthesizing flexible embedded electronic components and subsystems on the SRAM-based FPGA or SoC of reconfigurable systems 105 and 107 by identifying computational tasks of synthesized in the programmable logic in which dynamic partial reconfiguration can used with a hardware architecture or reconfiguration bitstream. The hardware architecture or reconfiguration bitstream of reconfigurable systems can download from a reconfiguration computing server 101 that remains physically unchanged and hosts the computing architecture or reconfiguration bitstreams of many individual reconfigurable systems 105 and 107. The placement/routing software modules 1025, 1055 and 1075 may interact with the reconfigurable systems 101, 105 and 107 to provide the evolutionary power of the reconfigurable systems with the reconfiguration bitstream manipulation and configuration techniques. The placement/routing software modules 1025, 1055 and 1075 may execute a sequential application by partitioning the SRAM-based FPGAs of each reconfigurable system 101, 105 and 107 into multiple hardware stages that are executed one after other (batch process), in a time-multiplexed way. Moreover, for a fine-grained, coarse-grained or multi-grained FPGA architecture, configuration information or bitstream refers to the data bits sent to the FPGA device to set the state of all its resources, logic and interconnection.

In one embodiment of the present invention, the placement/routing software modules 1025, 1055 and 1075 running on the reconfigurable systems 101, 105 and 107 may perform one of reconfigurations performed during the application execution or to the device activity while the reconfiguration is in progress: compile-time reconfiguration where the entire configuration is determined at compile-time and does not change throughout system operation; shutdown reconfiguration where the reconfiguration cannot be performed while the device is in operation; dynamic reconfiguration allowing that parts of the system may be reconfigured while other parts are running, without disruption. With dynamic reconfiguration the reconfiguration execution is partitioned into time-multiplexed tasks.

FPGA reconfiguration consists in reprogramming the configuration memory by downloading a sequence of bits known as bitstream onto it. These data define the operation (i.e. functionality) to be processed by the combinational and sequential logic resources present in the FPGA device. Like this, the placement/routing software modules 1025, 1055 and 1075 may perform either the entire FPGA configuration memory is re-written (full configuration of the device) or only a subset of this needs to be changed (partial reconfiguration). Also the placement/routing software modules 1025, 1055 and 1075 may use one of downloading mechanisms: serial access configuration where the configuration storage elements are connected as a large scan chain around the entire chip; random access configuration where the reconfiguration cells for FPGA devices can be accessed in the same way as a standard RAM; windowing configuration where with a very flexible windowing mechanism small areas of the device can be programmed independently of each other. The placement/routing software modules 1025, 1055 and 1075 may also employ a bitstream format composed of a series of configuration commands and configuration data corresponding to the data written into the FPGA configuration memory, where the commands encompass the handling of the internal registers of the configuration logic. The placement/routing software modules 1025, 1055 and 1075 may employ one of interface mechanisms: serial or parallel bus; multiplexing for multi-context FPGAs to map successive configurations from the configuration memory to the logic resources of the FPGA device by swapping a selected inactive configuration memory context or plane into the active one; wormhole run-time configuration where multiple independent computational streams can configure the system simultaneously through multiple access ports; pipelined configuration where one partition is operative while the other is concurrently reconfigured to instantiate there the next sequential task to compute so that configuration and execution coexist at the same point in time but applied to different stages in the pipe.

The placement/routing software modules 1025, 1055 and 1075 may employ external interface for the bitstream repository of the configuration data such as non-volatile memory device, or a secondary PLD, or even a general-purpose microprocessor. Also the reconfiguration service, and the reconfiguration software module, may employ a dedicated internal processor, either a hard core attached to the FPGA or even a soft-core processor synthesized in the own FPGA fabric, being able to access to the FPGA configuration memory can take charge of the configuration protocol. The reconfiguration service, and the reconfiguration software module may use embedded algorithms for dynamic synthesis, mapping, placement and routing on chip during run-time. That is, the reconfigurable system itself shall build the required partial bitstream on-demand and self-download it instead of picking it up, already prebuild, from any data repository.

Also the placement/routing software modules 1025, 1055 and 1075 may employ the bitstream relocation known as a partial bitstream stored in the repository can be placed in any of the PR regions available in the FPGA if the bitstream addressing mechanism is modified to point to the specific PR region, as well bitstream defragmentation to solve the placement conflicts. Furthermore the placement/routing software modules 1025, 1055 and 1075 may employ the two-step configuration or prioritized startup to reduce the startup time of an FPGA-based system as much as possible by performing the configuration of the full FPGA device in two steps, configuration caching to reduce the overall reconfiguration overhead, and configuration prefetching by loading a configuration before it is actually required to reduce the reconfiguration latency.

In one embodiment of the present invention, each reconfigurable system of 101, 105 and 107 with its operating system of 1024, 1054 and 1074 is a multi-processing system, composed of two or more hardware or software controllers able to reach a concurrent processing of several threads in parallel, in order to overlap the reconfiguration of one task with the execution of another task. Like this, one application such as the placement and routing module or processor 1025 can perform the reconfiguration of a placement/routing (PR) region to fit there a task Tj while other application such as the reconfiguration management module or processor 1022 is simultaneously executing the functional task Ti scheduled at that time placed outside that PR region. Once the task currently in execution Ti finishes, the application flow can switch to process the next task Tj scheduled in the reconfigured PR region.

The placement/routing software modules 1025, 1055 and 1075 may apply the bitstream compression and decompression to improve the efficiency of the bitstream format and its transfer for the improvement of configuration latency. Furthermore, some parts of an active stage of the placement/routing software modules 1025, 1055 and 1075 mapped in hardware resources can even be reconfigured on the fly, just while others at the same moment continue operating undisturbed in reconfigurable system. The placement/routing software modules 1025, 1055 and 1075 takes charge of performing the online/offline full/partial reconfiguration of the programmable logic. The placement/routing software modules 1025, 1055 and 1075 may achieve the maximum reconfiguration throughput on the downloadable reconfiguration bitstream file stored in an external memory architected as a shared resource accessible concurrently by several reconfigurable systems 105 and 107. The placement/routing software modules 1025, 1055 and 1075 may use a reconfigurable controller already embedded in commercial devices such as Atmel AT94K FPSLIC, Altera Excalibur SoPC and Xilinx Virtex-4 FPGA.

In one embodiment of the invention, the reconfiguration management software module 1022 running on the server of IaaS may interrogate each reconfigurable system 105 and 107 to find out why the computing service 100 is doing reconfiguration tasks, and the reconfiguration management 1022 also maintain an abstract view of what the reconfigurable systems 105 and 107 are doing and how the computing service 100 creates the reconfiguration bitstreams for evolution of the reconfigurable systems 105 and 107. By the way, the network management modules 1056 and 1076 enable the reconfigurable system 105 and 107 to communicate other system in order to configure FPGA/SoC devices located in each other system, and to interact with the data center server of computing service 101. With these two main application modules of 1021 and 1022, the computing service 100 may provide neuroplastic reconfiguration bitstream for a reconfigurable systems 105 and 107 to have some sort of open-ended internal goals that moderate, control its behavior in unprescribed problems and events.

In one embodiment of the present invention, the reconfiguration management software module 1022 running on the IaaS server 101 of the computing service may generate the genotype of the reconfiguration architecture or FPGA/SoC bitstream deployable in reconfigurable systems 105 and 107 by evaluating the function and performance of the phenotype of the reconfigurable systems 105 and 107 affiliated in a reconfiguration network.

In one embodiment of the invention, the reconfigurable systems 105 and 107 are evolved searching a genotype from hardware architecture network, which may be a reconfigurable device with better performance, and cloning the genotype reconfiguration bitstream and downloading the bitstream into the FPGA resources of each the remaining devices to be configured. Reconfigurable systems 105 and 107 associated in the reconfiguration network map to a open-ended evolution by resembling the genotype of hardware architecture or FPGA/SoC bitstream in each reconfigurable architecture network. The population of reconfigurable systems 105 and 107 in the network may be increased to the number of which the computing systems 105 and 107 in the network gets the open-ended evolution.

In one embodiment of the invention, the reconfiguration management software module 1022 may exploit an introspective machine such as Lamarckian evolution for the evolution of reconfigurable systems 105 and 107. The reconfiguration management module 1022 combine many different configurations together downloaded from the reconfigurable systems 105 and 107, and create a generally stable configuration to download into the members in each morphogenesis network of reconfigurable systems 105 and 107. Also, the reconfiguration management module 1022 may exploit an optimization tools which presume a predefined searching and adaptation problem in the morphogenesis network.

As the embodiment of the present invention, the network managements software module 1021 running on the server 101 of the computing service 100, and the network management software module 1056 and 1076 running on the reconfigurable system 105 and 107 may include a language parser of semantics or lexical analyzer converting sequence characters included in the header text in the reconfiguration architecture data, to a sequence of tokens to describe the evolution control action and evolution status of reconfigurable systems 105 and 107.

In one embodiment of the invention, each reconfigurable system, 105 and 107, coupled with sensors of different types, may have each operating system 105 and 1074 employing an application software module comprising one of multilayered-neural-network components for self-adaptation, so that it can make local decisions on different time scales, uncertain and incorrect information from the environment etc. The design parameters and partial reconfiguration bitstreams of adaptation generated by these autonomous components are downloaded back to the data-center server 101 of the reconfiguration service 100, so to bring about not only the neuroplasticity and morphogenesis of reconfigurable systems 105 and 107 but also the neuroplasticity of the reconfigurable data-center server 101. The autonomous components as application software modules incorporated with each operating system 1024 running on reconfigurable systems 101 may include multiple neural networks, genetic or fuzzy algorithms, deep learning and multilayer perception and classification. With these expert modules the reconfigurable system 101, 105 and 107 may handle conflict between the sub-system, deal with inconsistency so to maintain a certain amount of persistence in its behaviors. The reconfigurable system 105 and 107 will contain a number of finite or renewable resources in the devices of SDRAM/DDR based FPGA 106 and 108, and SoC 1053. These resources are managed over the life time of the reconfigurable system 105 and 107 as well as the computing server 101 of IaaS for reconfiguration service.

In one embodiment of the invention, any reconfiguration application software modules running on the FPGAs of server 101, and the application software modules running in the FPGAs of embedded controller 105 and 107, may provide trusted cloud computing such as bitstream encryption by exploiting the certain of security features of FPGA such as physical unclonable functions and true random-number generators, cryptographic algorithms performed in a hardware crypto 1027 such as advanced encryption standard and elliptic curve cryptography, hardware-based firewall and digital signature. Moreover the hardware accelerators 1026 running on the FPGAs in the computing service 100 offers advantages over software approaches because the hardware can perform low-latency data encryption and decryption. Thus, all of the information that the computing service 100 of IaaS manages can be sent, received and stored encrypted instead of plaintext, guarding it against cyber attack.

FIG. 2 illustrates a reconfigurable system 200 with the reconfigurable device of FPGA 202 employing the main controller 210 for the network-based dynamic reconfiguration of IoT embedded systems, according to another embodiment of the present invention. The reconfigurable system 200 includes a reconfiguration memory 203 as the repository of reconfiguration data or bitstream download from the cloud computing server of the neuroplastic reconfiguration service 100. The placement /routing application module 1055 performs with the FPGA memory 2021 the reconfiguration tasks of the placement and routing of the resources of FPGA device 202. The network management application 1056 incorporating with an operating system 1054 such as Linux, VxWork and FreeRTOS initiates a networking command of transporting the reconfiguration data via a Ethernet transceiver 204 wired to Internet connection 2041, downloaded into the reconfiguration memory 203 from a server providing a reconfiguration computing service 100 through the connection 2041. Also the various functionalities of the FPGA resources as well as the input and output ports 2026 can be configured by the use of the bitstream downloader of serial interface such as JTAG interface 2024, although the binary files of application software and operating system are downloaded via JTAG interface 2014 for debugging and verifying the functionality of these software modules. Furthermore the reconfiguration data or bitstream may be downloaded into the reconfiguration memory 203 such as non-volatile Flash memory via the serial peripheral interface (SPI). The computing controller 201 for dynamic reconfiguration and computing operation have a different elements of peripheral interfaces including the parallel memory interface 2013 connected to the FPGA device 202, the FPGA power switching module which provides a selection of FPGA operations by switching various sources of power supplies via the signals 2051 to the FPGA device 202, and the FPGA command and status signals 2011 needed in the configuration of the FPGA device 202. By the use of memory interface 2013, the command and status signals of the computing controller 201 are transmitted to the FPGA device 2013 while the data obtained from a sensor 207 via the connection 2023, as well as the computation data stored in a external memory 208 with a memory interface controller of the connection 2022, are reported to the computing controller 201 by setting a flag to the controller with an interrupt signal 2025. The FPGA device 202 may restart its computing and operation tasks via the reset signal 2012 from the controller 201 as well as the power switching signals 2051 from the power switching module 205, while the computing controller 201 can boot up the application modules by the reset signal 2017. The computing controller 201 installed in the reconfigurable system 200 may include one of general-purpose inputs and outputs (GPIOs) and analog-signal conversion components of analog-to-digital converter (ADC) and digital-to-analog (DAC), so to work as an industrial Ethernet controller based on the industrial Ethernet communication protocols such as EtherCAT, EtherNet/IP, PROFINET, CC-Link IE and ModBus/TCP.

FIG3 illustrates a reconfigurable system 300 with the reconfigurable devices of FPGA 302, 303 and 304 employing a master of the reconfiguration controller 301, according to another embodiment of the present invention. The FPGA device 303 works as PSOC comprising a Ethernet transceiver 306 with media-independent interface (MII) wired to giga Ethernet connection while the order two device interfaced with one wireless controller 307 including Wi-Fi and long-term-evolution (LTE) system-on-chips are available in the signal processing blocks. The reconfigurable system 300 includes the multiple reconfiguration repositories of the reconfiguration memory 308 to store the reconfiguration data or bitstream download from the cloud computing server of the neuroplastic reconfiguration service 100. The placement-routing application software module 1055 running on the controller 301 performs the reconfiguration tasks of the placement and routing of the resources of FPGA devices 302, 303 and 304. Also the network management software module 1056 running with its operating system may initiates a command of receiving the reconfiguration data via a Ethernet transceiver 305 with reduced media-independent interface (RMII) wired to Ethernet connection 3051, downloaded into the reconfiguration memories 308 from a server providing a reconfiguration computing service 100. Also the various functionalities of the FPGA resources as well as the input and output ports 3031 can be configured by the use of the bitstream downloader of serial interface such as each JTAG interface 3021, 3031 and 3041. Furthermore the reconfiguration data or bitstream may be downloaded into the reconfiguration memories 308 such as non-volatile Flash memory via the serial peripheral interface (SPI) 3081. The main controller 301 have a different elements of peripheral interfaces including the general-purpose inputs and outputs connected to the FPGA devices 302, 303 and 304, the FPGA bus controller 309 managing the control and selection of the data bus interconnections 3091 between the master and the slaves of reconfiguration-data transmission. The sensor data and computation results processed in each FPGA devices 302, 303 and 304 are sent to the computing controller 301 by setting a flag to the controller with interrupt signals 3011. Each FPGA device of 302, 303 and 304 may restart its computing and operation tasks via the reset signal 3022, 3032 and 3042 respectively, from the controller 301.

The computing service software of the present invention, as cloud based IaaS for the neuroplastic IoT platform, may enable innovative differentiation by synthesizing optimized computations and connections relative to the service requested, bringing added value to the end user by delivering a specific quality of service (QoS). The neuroplastic IoT platform requires special attention to such design parameters as the performance, customization and security of the computing architecture of the cloud computing server as well as the reconfigurable computing systems deployed in real application fields.

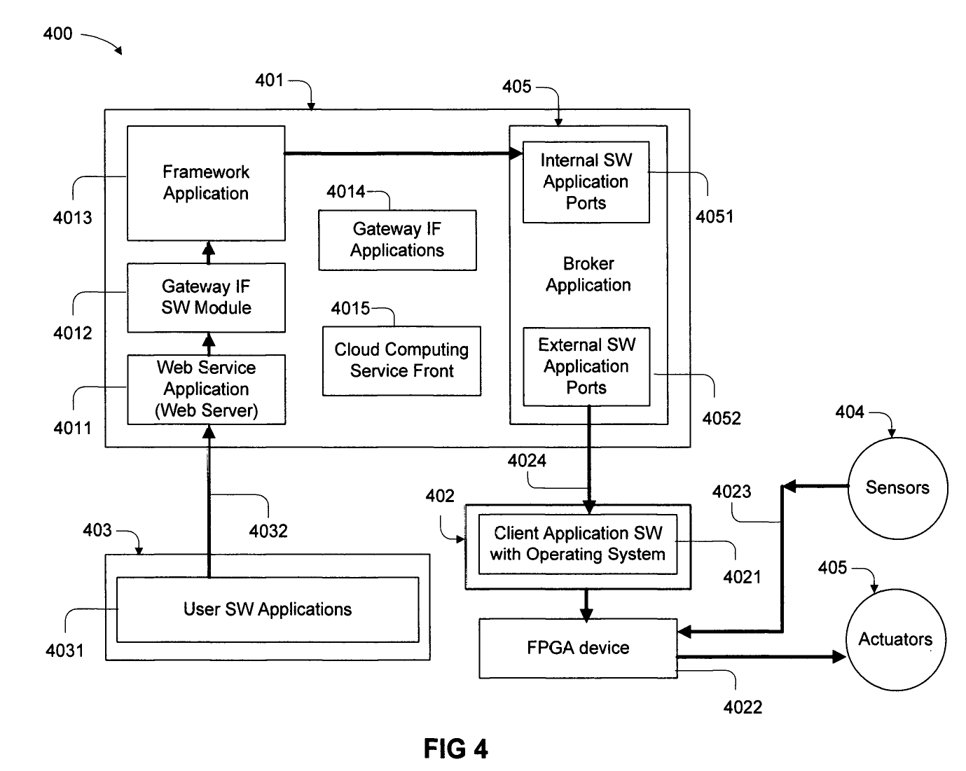

FIG. 4 illustrates an IoT platform 400 consisting of a server-side application software 401 operated with the network management and placement/routing application software modules 1021 and 1022, and one of reconfigurable embedded systems 402 having a FPGA device 4022, allowing an user application 403 to interact with the reconfigurable system 402 through the application 401 found on the cloud computing server of IaaS, according to another embodiment of the present invention. The server-side application software 401implemented on the cloud computing sever of IaaS, such as Elastic Compute (EC) in Amazon Virtual Private Cloud (VPC) or Virtual Machines (VM) in Microsoft Azure Cloud, may establish a data transmission pipeline between an user application software 403 to the reconfigurable system 402 by employing in a broker application module such as MQTT. The server application 401 may include a HTTP server and reverse proxy as well as an IMAP/POP3 proxy server, such as the NGINX server 4011. Also the gateway interface such as WSGI interface 4012, may be provided a connection between the web server 4011 and an application server such as the Python WSGI HTTP server 4012. The server application 401 may include other applications 4014 based on the gateway interface 4012, a web-service framework such as a Python micro-framework of FLASK 4013 as well as a web-service application of visualization or dashboard 4015. The server application includes a broker application 405 such as MQTT containing the internal ports 4051 connected to the web-service framework, as well as the external secure-socket-layer (SSL) ports 4052 by interfacing an Ethernet connection 4024 to the reconfigurable system 402. Moreover the application 4021 running in the reconfigurable system 402 may work as a client of the broker application 405. The user application software 403 may be a public Internet web client application containing many the user graphic interfaces and request services 4031.

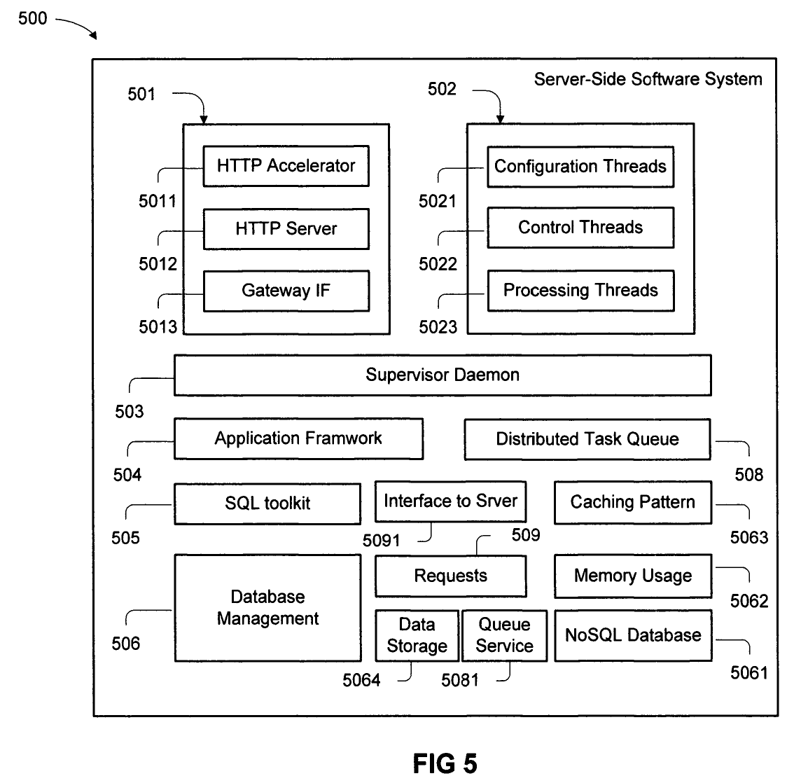

FIG. 5 illustrates a server-side application software 500 implemented together with the computing service software 100, including a web-server application 501 and computing application 502 found on the cloud computing server, according to another embodiment of the present invention. The web-server application may include a HTTP server 5012 such as NGINX, a HTTP accelerator 5011 such as VARNISH, and the gateway interface 5013 such as WSGI. The computing application 502 may include the reconfiguration application threads 5021 related to the reconfiguration network management and the placement routing, the control application threads 5022 for the operational control of reconfigurable systems, and the processing application 5023 for the computation of sensor data. The server application 500 may include an application framework 504, as the example of FLASK, a supervisor demon 503 to monitor and control a number of the installed application process as well as a high-level synchronous application interface to the event loop used in the application threads, for the Python example of GEVENT. Moreover the server application 500 should employ database system and management applications to provide users the various information given by the reconfigurable system and their reconfiguration data. The server application 500 may include a data storage 5064, for the example of Amazon cloud data storage S3, a SQL-based database toolkit 505 mapping relational database objects, for the example of Python SQLAlchemy and PgBouncer, and a non-SQL database, memcached 5061 such as libemcached for a memory cached server. The server application 500 may include a database management module 506 such as PostgreSQL, a process module of memory caching 5062 such as libmemcached, as well as of caching pattern 5063 such as Python package index of dogfile. The server application 500 may also include a distributed task queue such as C Celery, and a message queue service such as Amazon SQS. The server application 500 may include a request module 509 with the interface 5091 to web services such as BOTO-Python Interface to Amazon web services (AWS). The web-service applications implemented in the server-side application software 500 may be developed by the embedded script including one of PHP, ASP and Python language. The server-side application software 500 can be adapted to the industrial applications of supervisory control and data acquisition (SCADA).

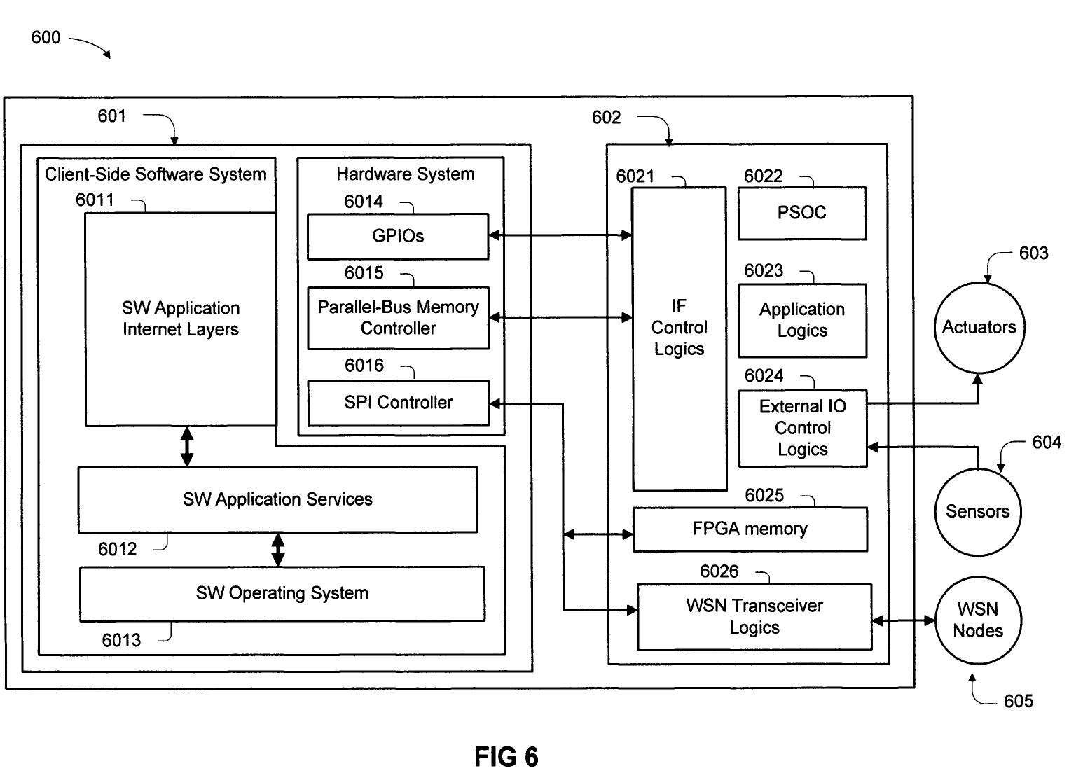

FIG. 6 illustrates a reconfigurable system 600 comprising a fixed-computing-hardware or non-reconfigurable controller 601, connected with a reconfigurable FPGA PSoC controller 602. The non-reconfigurable controller may include the peripheral controllers 6014, 6015 and 6016 of GPIOs, parallel-bus memory interface and SPI respectively, allowing the controller 601 to communicate with the PSOC controller 602. The non-reconfigurable controller 601 is running on an operating system or kernel 6013 incorporated with the software modules 6011 of Internet protocol layers and user applications, for the example of MQTT client application module. The non-reconfigurable controller 601 may also provide a client-side application 6012 of the web service, implemented with one of Python codes and Java scripts. The PSoC controller 602 with FPGA memory 6025 for the reconfiguration may include a programmable system-on-chip processor 6022, the control logics 6021 of the GPIO and parallel-bus memory interfaces, and the application processing logics or IP cores 6023, related to the digital-logic functional tasks such as high-speed data acquisition, double-data-rate memory control, signal and image processing. The PSoC controller 602 may also include the IO port control logics to interface with external actuators 603 and sensors 604, as well as a dedicated network control logics 6026 to implement wireless sensor network (WSN) transceiver in FPGA, linked a number of WSN nodes or sensors 605.

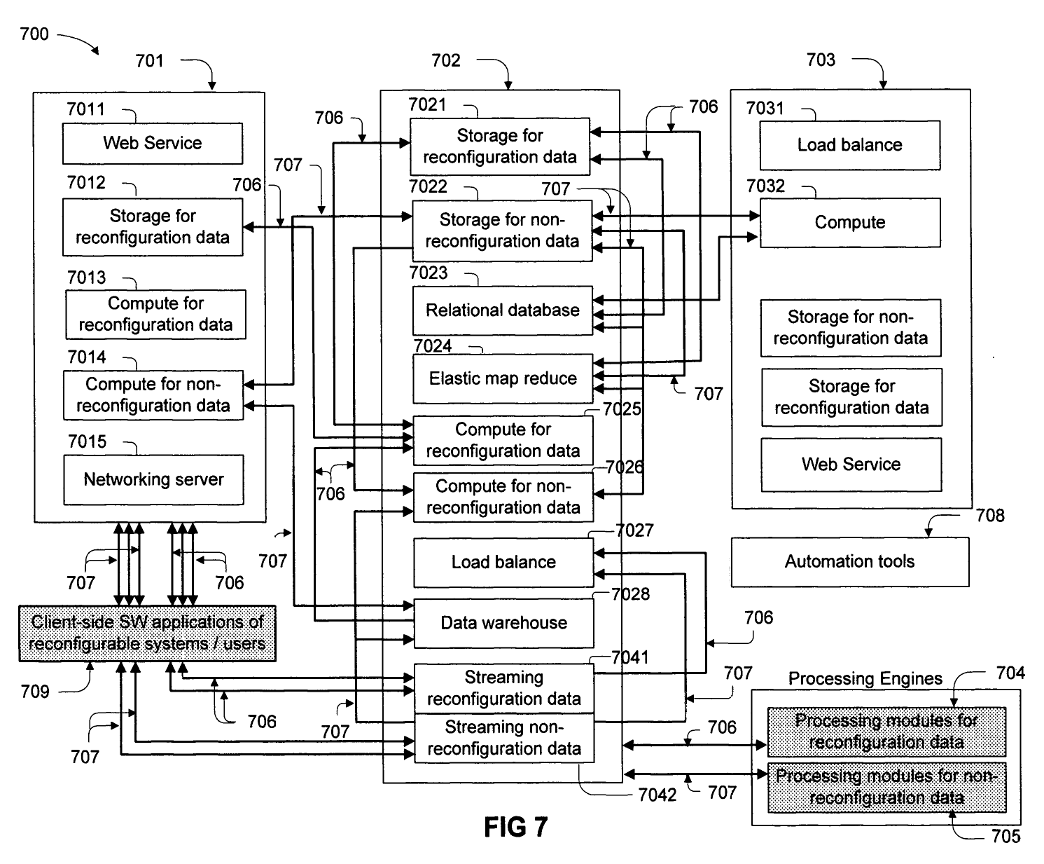

FIG. 7 illustrates a cloud-computing architecture 700 providing the neuroplastic reconfiguration service 100, implemented in a cloud server of IaaS such as AWS cloud, according to another embodiment of the present invention. The cloud-computing architecture 700 as the structure of the system comprising cloud resources, services, middleware, and software components, and the relationship between them has two data-path tracks 706 and 707: the first track 706 is the data-path of streaming reconfiguration data for dynamic reconfiguration, and the second track 707 is the data-path of streaming the information on the requests on the user services or the sensor data retrieved from a number of reconfigurable systems and users 709. The cloud-computing architecture 700 may have three virtual network layers interconnecting the cloud resources or computes, for the example of Amazon Virtual Private Cloud (VPC) : the first virtual network layer 701 for application/web-service 701, the second virtual network layer 702 for processing, and the third virtual network layer 703 for streaming reconfiguration and information data. The cloud-computing architecture 700 may also include two compute platforms 704 and 705, so to run codes of the network and reconfiguration management and the placement/routing application software modules 1021, 1022 and 1025 without provisioning or managing servers, for the example of AWS Lambda. The first compute platform 704 may run codes of processing reconfiguration data pertinent to the neuroplastic dynamic reconfiguration in the computing service 100, while the second compute platform 705 may run codes of processing the information and sensor data, and evaluating the reconfigurable system performance in the computing service 100. The cloud-computing architecture 700 may employ an automation platform 708 to make the computing service 100 easier to deploy, for the examples of Chef, Puppet and Ansible. The first virtual network layer 701 may include the subnet or range of IP addresses to interconnect the cloud resources comprising two compute platforms 7013 and 7014 of processing the reconfiguration data and the information data respectively, and the reconfiguration data storage 7012 such as AWS S3, as well as the web services 7011, such as AWS ElasticCache, working in back side to the front of networking broker server 7015. The second virtual network layer 702 may include the subnet of IP addresses to interconnect the cloud resources comprising two compute platforms 7025 and 7026, two data storages 7021 and 7022, and two streaming-data platforms 7041 and 7042 such as AWS Kinesis, of processing, storing and loading the reconfiguration data and the information data respectively, as well as the web services 7011, such as AWS ElasticCache, working in back side to the front of networking broker server 7015. The second virtual network layer 702 may incorporate with a relational database platform 7023 such as AWS RDS, a web-service framework 7024 such as AWS EMR, a network load balancer 7027 such as AWS ELB to automatically distribute incoming application traffic across multiple computes, a data warehouse 7028 such as AWS Redshift. The third virtual network layer 703 may incorporate with one load balancer 7031, one compute platform 7032, two data storage, and one web service.

One of ordinary skill in the art will realize that a different embodiment of the present invention can employ different types of the computing server 101 and the embedded systems 105 and 107. For example, in the embodiments described above, one of the embedded systems 105 and 107 can be known the controller installed in robots, drones, smart cars, smart-home electronics, health-care devices, smart factories and grids as well as a distributed computing system comprising multiple processors attached or embedded in objects. When connected to a computing server, these controllers are capable of autonomously configuring its FPGA devices with reconfiguration data or FPGA bitstreams provided from the computing service of dynamic reconfiguration.

While the present invention has been described with reference to the specific embodiments thereof, it should be understood that the foregoing relates to preferred embodiments of the invention and that modifications may be made without departing from the spirit and scope of the invention as set forth in the following claims.

What is claimed is:

1. An computing service providing the reconfiguration data of FPGA-based hardware architecture by networking reconfigurable systems including reconfigurable device such as FPGA and PSoC, the service comprising:
establishing a network connection to interact with a plurality of reconfigurable systems, designated as one of the provider and subscriber of reconfiguration data,
requesting a provider not only to transmit one of sensor data, but to report its computation results performed with the sensor data to the computing service, monitoring the performance of each reconfigurable system by analyzing the sensor data transmitted to the computing service,
retrieving reconfiguration data from a memory repository coupled in the provider, searching one of reconfiguration data from a computing-service database, pertinent to that each subscriber will work with better performance, evaluating reconfiguration data on the basis of the performance of each subscriber,
transferring the reconfiguration data into a memory repository coupled in each subscriber allowing to configure its FPGA devices by downloading the reconfigurable data stored in the memory repository to the FPGA devices; and
wherein the computing service is implemented on an cloud computing server of IaaS as well as a local network server for monitoring IoT devices.

2. An computing service as recited in claim 1, wherein the reconfiguration data is sent from the providers for the computing service to provide a reconfiguration data appropriate to the subscribers.

3. An computing service as recited in claim 1, wherein the memory repository is one of non-volatile memory devices externally interfaced to the FPGA device including flash memory and magnetoresistive RAM, and the FPGA memory internally positioned in the FPGA device.

4. An computing service as recited in claim 1, wherein the network is to allow the capability to send and receive data including one of the reconfiguration data and the senor data of reconfigurable systems.

5. An computing service as recited in claim 1, further comprising:
integrating one of synthesis, floorplan, map, placement and routing to generate reconfiguration data with FPGA resources.

6. An computing service as recited in claim 1, further comprising:
providing a homepage on a website giving access to different elements of the computing service's functionality.

6. An computing service as recited in claim 1, further comprising:
providing a plurality of dashboards giving access to different elements of the sensor data or the functionality of reconfigurable systems.

7. An computing service as recited in claim 1, further comprising:
encrypting the reconfiguration data to provide an entrusted hardware architecture to reconfigurable systems.

8. An computing service as recited in claim 1, further comprising:
brokering with the providers and the subscriber of reconfiguration data,

10. An computing service as recited in claim 1, further comprising:
generating the reconfiguration data by adapting the reconfigurable system in the response to one of user-service requests and environmental stimuli.

11. An computing service as recited in claim 1, wherein the performance of reconfigurable systems includes one of the FPGA resources and the results obtained from the simulated or actual behaviors of reconfigurable systems.

12. An computing service as recited in claim 1, wherein each of the providers and the subscriber of reconfiguration data is one of the user of reconfigurable embedded systems, a reconfigurable embedded system by itself, and a FPGA-based computing server of IaaS.

13. An computing service as recited in claim 1, wherein the reconfiguration data includes the FPGA bitstreams related to one of the hardware computing architectures of PSoC and the functional logic circuits of IP cores.

14. An computing service as recited in claim 1, wherein each of reconfiguration data includes a header providing the information of reconfiguration-data network with the IoT locations of the provider and subscriber, wherein each of the IoT locations is the Internet-Protocol address with the port of reconfiguration application.
